(19) United States
(12) Patent Application Publication
(10) Pub. No.: US 2019/0130220 A1
(43) Pub. Date: May 2, 2019

(54) DOMAIN ADAPTATION VIA CLASS-BALANCED SELF-TRAINING WITH SPATIAL PRIORS

(71) Applicant: GM GLOBAL TECHNOLOGY OPERATIONS LLC, Detroit, MI (US)

(72) Inventors: Yang Zou, Pittsburgh, PA (US); Zhiding Yu, Pittsburgh, PA (US); Vijayakumar Bhagavatula, Pittsburgh, PA (US); Jinsong Wang, Troy, MI (US)

(21) Appl. No.: 15/949,519

(22) Filed: Apr. 10, 2018

Related U.S. Application Data
(60) Provisional application No. 62/578,005, filed on Oct. 27, 2017.

(51) Int. Cl. G06K 9/62; G06K 9/00; G06T 7/143; G05D 1/00; G05D 1/02; G06N 3/08

(52) U.S. Cl. CPC G06K 9/6257; G06K 9/00791; G06K 9/627; G06T 7/143; G05D 1/0088; G05D 1/0238; G05D 2201/0213; G06N 3/08; G06T 2207/20081; G06T 2207/20084; G06T 2207/30252; G06K 2209/21; G05D 1/0214

(57) ABSTRACT

A vehicle, system and method of navigating a vehicle. The vehicle and system include a digital camera for capturing a target image of a target domain of the vehicle, and a processor. The processor is configured to: determine a target segmentation loss for training the neural network to perform semantic segmentation of a target image in a target domain, determine a value of a pseudo-label of the target image by reducing the target segmentation loss while providing aa supervision of the training over the target domain, perform semantic segmentation on the target image using the trained neural network to segment the target image and classify an object in the target image, and navigate the vehicle based on the classified object in the target image.

### CROSS REFERENCE TO RELATED APPLICATIONS

This application claims priority from U.S. Provisional Application Ser. No. 62/578,005, filed on Oct. 27, 2017, the contents of which are incorporated herein by reference in their entirety.

### INTRODUCTION

The subject disclosure relates to a system and method for adapting neural networks to perform semantic segmentation on images captured from a variety of domains, for autonomous driving and advanced driver-assistance systems (ADAS).

In autonomous vehicles and ADAS, one goal is to understand the surrounding environment such that information can be provided to either the driver or the vehicle itself to make decisions accordingly. One way to meet this goal is to capture digital images of the environment using an on-board digital camera and then identify objects and drivable spaces in the digital image using computer vision algorithms. Such identification tasks can be achieved by semantic segmentation, where pixels in the digital image are grouped and densely assigned with labels corresponding to a predefined set of semantic classes (such as car, pedestrian, road, building, etc.). A neural network can be trained for semantic segmentation using training images with human annotated labels. Often, due to the limitations on annotation resources, the training images may only cover a small portion of the localities around the world, may contain images under certain weathers and certain periods in a day, and may be collected by specific types of cameras. These limitations on the source of the training images are particular to the domain of the training images. However, it is quite common that a vehicle is operated at a different domain. Since different domains can have different illumination, street styles, unseen objects, etc., a neural network trained in one domain does not always work well in another domain. Accordingly, it is desirable to provide a method of adapting a neural network trained for semantic segmentation in one domain in order to operate the neural network effectively in another domain.

### SUMMARY

In one exemplary embodiment, a method of navigating a vehicle is disclosed. The method includes determining a target segmentation loss for training a neural network to perform semantic segmentation on a target domain image, determining a value of a pseudo-label of the target image by reducing the target segmentation loss while providing a supervision of the training over the target domain, performing semantic segmentation on the target image using the trained neural network to segment the target image and classify an object in the target image, and navigating the vehicle based on the classified objects in the target image.

The method further includes determining a source segmentation loss for training the neural network to perform semantic segmentation on a source domain image, and reducing a summation of the source segmentation loss and the target segmentation loss while providing the supervision of the training over the target domain. The method can further include reducing the summation by adjusting parameters of the neural network and the value of the pseudo-label.

In various embodiments, determining the value of the pseudo labels of the target image includes reducing the target segmentation loss over a plurality of segmentation classes while providing the supervision to each of the plurality of segmentation classes. Determining the target segmentation loss further includes multiplying the spatial prior distribution for the segmentation class by a class probability of a pixel being in the segmentation class. The neural network can be trained using adversarial domain adaptation training and/or a self-training domain adaptation training. Supervision of the training can include performing class-balancing for the target segmentation loss. A smoothness algorithm can be applied during the semantic segmentation of the target image.

In another exemplary embodiment, a navigation system for a vehicle is disclosed. The system includes a digital camera for capturing a target image of a target domain of the vehicle, and a processor. The processor is configured to: determine a target segmentation loss for training the neural network to perform semantic segmentation of the target image in the target domain, determine a value of a pseudo-label of the target image by reducing the target segmentation loss while providing a supervision of the training over the target domain, perform semantic segmentation on the target image using the trained neural network to segment the target image and classify objects in the target image, and navigate the vehicle based on the classified object in the target image.

The processor is further configured to determine a source segmentation loss for training the neural network to perform semantic segmentation on a source domain image, and reduce a summation of the source segmentation loss and the target segmentation loss while providing the supervision of the training over the target domain. In one embodiment, the processor is further configured to reduce the summation by adjusting a parameter of the neural network and the value of the pseudo-label. The processor is further configured to determine the value of the pseudo-label of the target image by reducing the target segmentation loss over a plurality of segmentation classes while providing the supervision to each of the plurality of segmentation classes. The processor is further configured to multiply a spatial prior distribution for the segmentation class by a class probability of a pixel being in the segmentation class.

In yet another exemplary embodiment, a vehicle is disclosed. The vehicle includes a digital camera for capturing a target image of a target domain of the vehicle, and a processor. The processor is configured to determine a target segmentation loss for training the neural network to perform semantic segmentation of the target image in the target domain, determine a value of a pseudo-label of the target image by reducing the target segmentation loss while providing a supervision of the training over the target domain, perform semantic segmentation on the target image using the trained neural network and the pseudo-label to segment the target image and classify an object in the target image, and navigate the vehicle based on the classified object in the target image.

The processor is further configured to determine a source segmentation loss for training the neural network to perform semantic segmentation on a source domain image, and reducing a summation of the source segmentation loss and the target segmentation loss while providing the supervision of the training over the target domain.

In one embodiment, the processor is further configured to reduce the summation by adjusting a parameter of the neural network and the value of the pseudo-labels. The processor is further configured to determine the value of the pseudo-labels of the target image by reducing the target segmentation loss over a plurality of segmentation classes while providing the supervision to each of the plurality of segmentation classes. The processor is further configured to multiply a spatial prior distribution for a segmentation class by a class probability of a pixel being in the segmentation class to determine the target segmentation loss. The processor is further configured to apply a smoothness algorithm to the semantic segmentation of the target image.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an illustrative trajectory planning system associated with a vehicle in accordance with various embodiments;

FIG. 2 shows an illustrative digital image obtained by an on-board digital camera of the vehicle as well as a semantically segmented image that corresponds to the digital image;

FIG. 3 schematically illustrates methods for training and operation of a neural network;

FIGS. 4A and 4B show various spatial priors that are obtained during training of the neural network in the source domain;

FIG. 5 shows an illustrative digital image obtained in a target domain for semantic segmentation;

FIG. 6 shows an unaided semantic segmentation image of the digital image; and

FIG. 7 shows a semantic segmentation image after neural network adaptation such has been performed.

### DETAILED DESCRIPTION

The following description is merely exemplary in nature and is not intended to limit the present disclosure, its application or uses. It should be understood that throughout the drawings, corresponding reference numerals indicate like or corresponding parts and features.

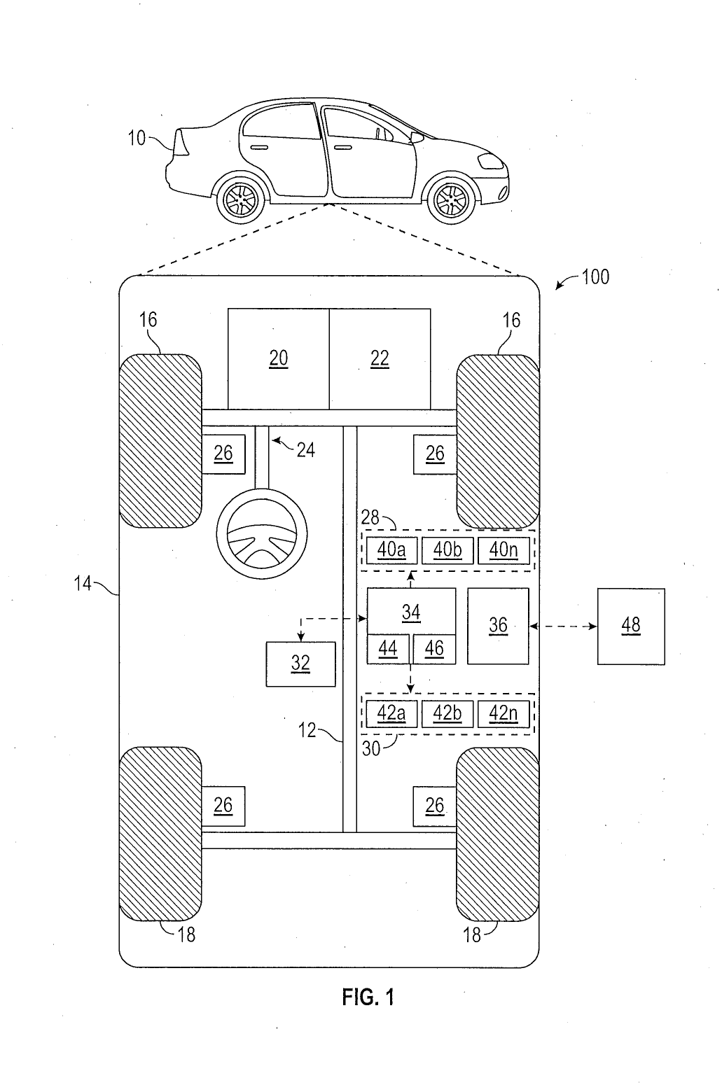

In accordance with an exemplary embodiment, FIG. 1 shows an illustrative trajectory planning system shown generally at 100 associated with a vehicle 10 in accordance with various embodiments. In general, system 100 determines a trajectory plan for automated driving. As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the trajectory planning system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, digital cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in automatically controlling the autonomous vehicle 10. In various embodiments, the data storage device 32 stores defined maps of the navigable environment. In various embodiments, the defined maps may be predefined by, and obtained from, a remote system. For example, the defined maps may be assembled by the remote system and communicated to the autonomous vehicle 10 (wirelessly and/or in a wired manner) and stored in the data storage device 32. The data storage device 32 further stores data and parameters for operation of a neural network in order to operate a neural network for semantic segmentation of digital images. Such data can include adaptation methods, spatial prior distribution data for features and other data, etc., as discussed herein. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generating control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the trajectory planning system 100 and, when executed by the processor 44, generates a trajectory output that addresses kinematic and dynamic constraints of the environment. For example, the instructions receive as input a digital image of the environment from an on-board digital camera and operate a neural network on processor 44 in order to perform semantic segmentation on the digital image in order to classify and identify objects in a field of view of the digital camera. The instructions can further perform a method of adapting the neural network to images obtained in different domains or at different localities. Methods for adaptation can include using spatial prior distributions determined during a training sequence for the neural network and smoothness operations. The controller 34 further controls the actuator system 30 and/or actuator devices 42a-42c in order navigate the vehicle with respect to the identified objects.

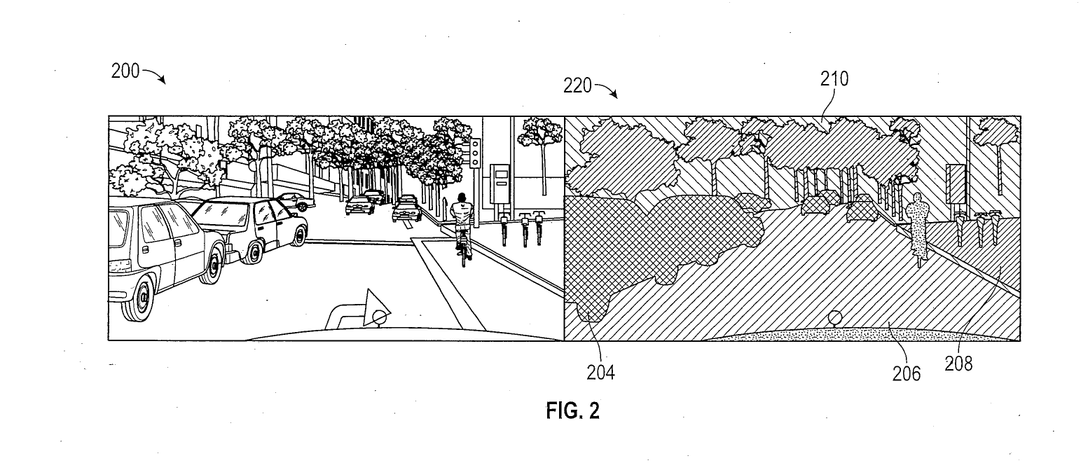

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

FIG. 2 shows an illustrative digital image 200 obtained by an on-board digital camera of the vehicle 10 as well as a segmented image 220 that corresponds to the digital image 200. In various embodiments, the image 220 can be segmented by an operator or created by a processor performing semantic segmentation. Semantic segmentation separates, delineates or classifies pixels in the digital image according to various classes that represent various objects, thereby allowing the processor to recognize these objects and their locations in the field of view of the digital camera. Semantic segmentation maps a pixel by its color and its relationship with other pixels into classes such as cars 204, road, 206, sidewalk 208 or sky 210. Additional pixel classes can include, but are not limited to, void, fence, terrain, truck, road, pole, sky, bus, sidewalk, traffic light, person, train, building, traffic sign, rider, motor, wall, vegetation, car, bike, etc.

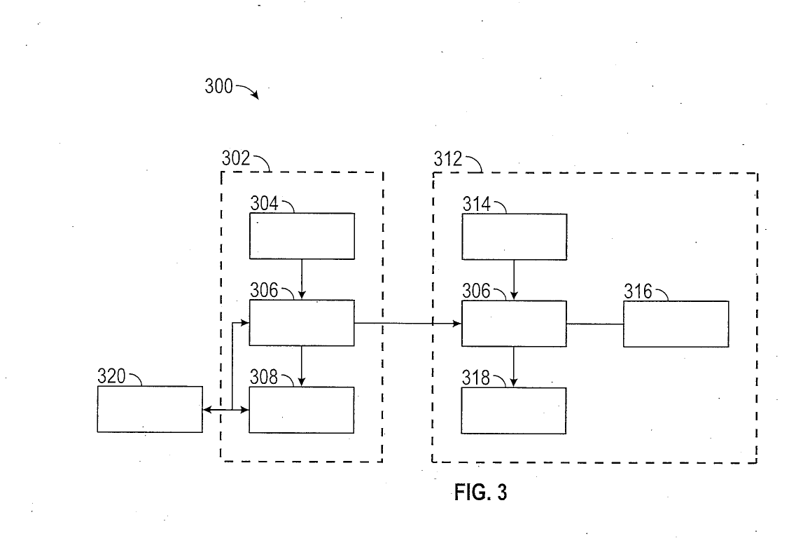

FIG. 3 schematically illustrates methods for training and operation of a neural network. Mathematically, a neural network can be regarded as a complicated nonlinear function, with an image to be segmented serving as an input to the neural network, the network predicted label maps serving as an output of the neural network, and the network parameters as coefficients that characterizes the function. With the network parameters initialized to selected values, the neural network 306 is trained in a first domain also referred to herein as a source domain 302. The neural network 306 is presented one or more images (also referred to herein as “source images” 304) along with the manually annotated ground truth labelled images 320 for the source domain 302. The ground truth labelled images 320 provide direct observations of the environment that can be used to train the neural network 306. The neural network 306 performs prediction or semantic segmentation of the one or more source images 304 to obtain segmented network-predicted labelled images 308. To train the neural network, network-predicted labelled images 308 are compared with ground truth labelled images 320, using a loss function to quantitatively measure how much the network predicted labelled images 308 differ from the ground truth labelled images 320. The training process refers to iteratively updating the parameters of the neural network 306, such that the loss is reduced, and the network-predicted labelled images 308 gradually match closely to the ground truths labelled images 320. The trained neural network 306 is provided to a second domain also referred to herein as a target domain 312. The neural network 306 performs semantic segmentation on target images 314 from the target domain 312 to obtain segmented labelled images 318. Due to differences that are evident between source domain 302 and target domain 312, such as different illumination, different geography, city vs. country, etc., the neural network 306 does not necessarily operate as well in the target domain 312 as it does in the source domain 302 in which it was trained. The neural network 306 therefore employs various adaptation methods 316 that are used with the neural network 306 in the target domain 312 in order to enable the neural network 306 to improve the quality of the segmented labelled image 318 in the target domain 312.

The neural network 306 is first trained by feeding source images 304 with ground truth 320 from source domain 302 to the neural network 306. Training the neural network 306 is performed by adjusting one or more neural network parameters w to obtain a minimal value of a loss function representing a domain segmentation loss or a loss that occurs during the segmentation process according to the network-predicted labelled image 308 and ground truth labelled image 320. A segmentation loss is defined as a product of a ground truth pixel label with a logarithm of a predicted class probability. The domain segmentation loss is a summation of these products over every class and pixel, and every image of the source domain. An exemplary segmentation loss function is shown in Eq. (1):

$${min}_{w} \{ - {\sum }_{s = 1}^{S} {\sum }_{n = 1}^{N} {y}_{s , n}^{T} log ( {p}_{n} ( w , {I}_{s} ) ) \} \qquad ( 1 )$$

where w is the neural network parameter, Iₛ is the source image 304, pₙ is the predicted class probability of the n^{th} pixel of the source image 304 as determined by the neural network (or a probability that the n^{th} pixel belongs a selected class), and y_{s,n}^{T} is a pixel label or column vector for the n^{th} pixel. The pixel label y_{s,n}^{T} is generally a one hot vector used to identify the n^{th} pixel. The logarithm of the predicted class probability is a negative number due to probabilities being between 0 and 1. Thus summations are multiplied by “−1” prior to minimization.

The network is then trained using adversarial training on both the source images 304 and target images 314 to improve the prediction performance of the neural network 306 on images from target images 314. The domain adversarial training is formulated as the optimization problem below

$$\begin{matrix} {L}_{total} = {L}_{seg} - {λ}_{A} {L}_{A} where & ( 2 ) \\ {L}_{A} = {max}_{{w}_{F}} {min}_{θ} \{ {\sum }_{s = 1}^{S} {\sum }_{n = 1}^{{N}_{S}} log ( {p}_{n} ( {w}_{F} , θ , {I}_{s} ) ) - {\sum }_{t = 1}^{T} {\sum }_{n = 1}^{{N}_{S}} log ( 1 - {p}_{n} ( {w}_{F} , θ , {I}_{t} ) ) \} & ( 3 ) \\ {L}_{seg} = {max}_{{w}_{F} , {w}_{S}} \{ {\sum }_{s = 1}^{S} {\sum }_{n = 1}^{{N}_{S}} {y}_{s , n}^{T} log ( {p}_{n} ( {w}_{F} , {w}_{S} , {I}_{s} ) ) \} & ( 4 )\end{matrix}$$

pₙ(w_{F}, θ, I_{s/t}) is the probability for the n^{th} pixel, in an image I_{s/t} of being predicted as from the source domain. I_{s/t} indicates that the image is from the source/target domain. The index tϵ{1,2, . . . , T}, nϵ{1,2, . . . , N} are the parameters for the domain discriminating network, which is built on top of the neural network parameter w_{F} corresponding to the feature generation network. Parameter w_{S} is the neural network parameter corresponding to the segmentation network. The parameters w_{F} and w_{S} form the segmentation network.

The above equations (2)-(4) can be solved by the following iterative process: 1) train a domain discriminator to distinguish features of the source domain from features of the target domain by solving the inner minimization problem of Eq. (3) via a method of stochastic gradient descent; and 2) train the feature extraction network w_{F} and w_{S} by solving the outer maximization of Eq. (3) combined with Eq. (4).

Once the neural network parameter w has been determined by domain adversarial training, self-training based domain adaptation is further used to better adapt the network to the target domain. The method is used to perform semantic segmentation on target images from the target domain. Domain adaptation methods are used to adapt the neural network to the target domain, thereby improving the effectiveness of the neural network in the target domain. Similar to domain adversarial training, self-training based domain adaptation also helps to improve the effectiveness of the neural network in the target domain by incorporating target images in multiple rounds or iterations of network training without requiring human annotated ground truths. However unlike domain adversarial training, self-training based domain adaptation adopts a loss function minimization or reduction training framework similar to traditional network training in Eq. (1) without the adversarial step in domain adversarial training. Since the target domain ground truths are not available, self-training based domain adaptation generates network predictions on target images and incorporates the most confident predictions in network training as approximated target ground truths (herein referred to as pseudo-labels). Once the network parameters are updated, the updated network regenerates the pseudo-labels on target images, and incorporate them for a next round of network training. This process is iteratively repeated for multiple rounds. Mathematically, each round of pseudo-label generation and network training can be formulated as minimizing the loss function shown in Eq. (2).

Once the neural network parameter w has been determined, it is used to perform semantic segmentation on target images from the target domain. Domain adaptation methods are used to adapt the neural network to the target domain, thereby improving an effectiveness of the neural network in the target domain. In order to perform domain adaptation in the target domain, a second loss function is minimized that describes a summation of a segmentation loss in the source domain and a segmentation loss in the target domain. A representative loss function for the process of domain adaptation is shown in Eq. (5):

$$\begin{matrix}min \\ \hat{y} , w\end{matrix} \{ - [ {\sum }_{s = 1}^{S} {\sum }_{n = 1}^{N} {y}_{s , n}^{T} log ( {p}_{n} ( w , {I}_{s} ) ) + {\sum }_{t = 1}^{T} {\sum }_{n = 1}^{N} {\sum }_{c = 1}^{C} {\hat{y}}_{t , n}^{( c )} log ( {p}_{n} ( c \vert w , {I}_{t} ) ) + {\sum }_{c = 1}^{C} {k}_{c} {\hat{y}}_{t , n}^{( c )} ] \} \qquad Eq . ( 5 )$$

such that

ŷ_{t,n} ∈ {{e|e ∈ [symbol] ^{C}}∪0} Eq. (6)

k_{c}>0, ∀c Eq. (7)

where I_{T} is the target image in the target domain, and pₙ is the predicted class probability. The term pₙ (c|w, Iₜ) is a probability that an n^{th} pixel of the target image Iₜ (as determined by the neural network having parameter w) is in class c. The segmentation loss in the source domain is represented by the first term (having summations over S and N) and the segmentation loss in the target domain is represented by the second term (having summations over T, N and C). The class term c appears only in the second term (i.e., the target domain). In the second term, the predicted class probability is multiplied by a pseudo-label ŷ_{t,n}^{(c)}. The pseudo-label ŷ_{t,n}^{(c)} is a scalar value for an n^{th} pixel in class c. The pseudo-label ŷ_{t,n}^{(c)} is a variable of the loss function that is adjusted in order to minimize the loss function of Eq. (5). Once the pseudo-labels have been determined, the target images can be incorporated to network training by minimizing Eq. (5) with respect to network parameters w while fixing the pseudo-labels can be used in calculations to perform semantic segmentation of the target image.

The third term Σ_{c=1}^{C}k_{c}ŷ_{t,n}^{(c)} is a constraint term that prevents the minimum value of the loss function from being zero or providing a trivial solution. Therefore minimizing the loss function of Eq. (5) includes determining a local minimum of the loss function rather than an absolute minimum of the loss function. The parameter k_{c} is a threshold value that supervises the training process on the target domain by controlling a strictness of the pseudo-label generation process for class c. In particular, supervision refers to controlling the values for k_{c} for each class in order to provide a constraint on the particular class, leading to a class-balanced framework for performing the neural network training, such as in self-training domain adaptation training. The selection of values can be used to prevent large classes (i.e., classes that include a large portion of the pixels) from overwhelming small classes (i.e., classes that include few pixels) and preventing the small classes from being subsumed by larger classes. As an illustrative example, large classes can include sky, road, buildings, etc., while small classes can include stop signs, telephone poles, etc. In a framework in which the neural network is self-training, one can count the frequency of occurrence of each class in images form the source domain and find a threshold of a certain class in which the proportion of pixels with predicted probabilities of that class greater than the threshold is equal to the source domain frequency. This threshold is then used to set the parameter k_{c}. Selecting different parameter values k_{c} for each class provides supervision to the training of the neural network in the target domain by constraining the classes from changing size when segmenting the target images.

In another aspect, the methods disclosed herein use spatial prior distributions to reduce the summation of the segmentation loss in the target domain and the segmentation loss in the source domain. Despite the variations between source domains and target domains, various features or objects tend to occur in the same or similar locations within digital images regardless of domain. For example, sky often occupies the upper part of the image, while road and sidewalk often stay at the bottom part. The probability distribution of these features in an image can be provided in a scalar field referred to herein as a spatial prior distribution. Spatial prior distributions are generally determined from images in the source domain when training the neural network and are then stored in the storage medium for use in the target domain. When the neural network is segmenting the target image, the spatial prior distribution can be used along with the target image in order to improve class probabilities in the target domain.

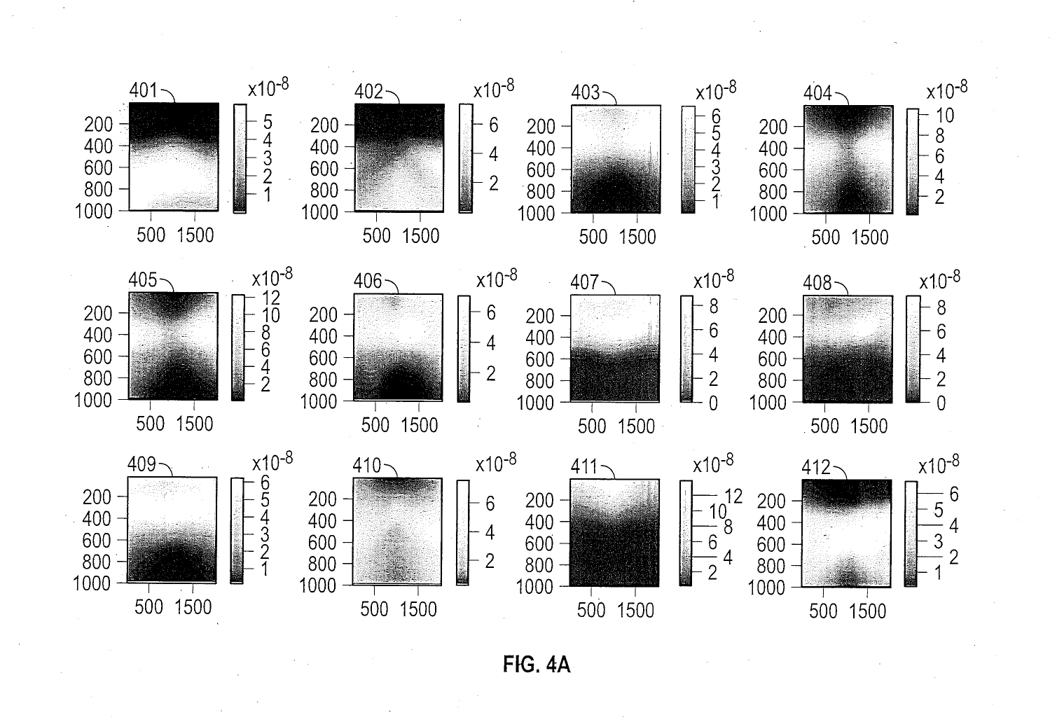

FIGS. 4A and 4B show various spatial priors that are obtained during training of the neural network in the source domain. The figures illustrate spatial priors of 19 different classes. In the top row of FIG. 4A, the classes, from left to right, are road 401, sidewalk 402, building 403, and wall 404. In the second row from left to right, the classes are fence 405, pole 406, traffic light 407, and traffic sign 408. In the third row, from left to right, the classes are tree vegetation 409, terrain 410, sky 411, and person 412. Continuing in the top row of FIG. 4B, from left to right, the classes are rider 413, car 414, truck 415, and bus 416. In the second row of FIG. 4B, from left to right, the classes are train 417, motorcycle 418 and bicycle 419. Each spatial prior distribution is shown for a digital image that is 2000 pixels across and 1000 pixels in height, although the digital image can have any particular dimension or aspect ratio in various embodiments. The light areas of a spatial prior distribution indicate a location of high probability of occurrence of the feature. The dark areas of a spatial prior distribution indicate a location of low probability of occurrence of the feature. The gray scale indicating the probabilities are indicated to the right of the spatial prior.

As an example, the spatial prior for a sidewalk 402 indicates that sidewalks tends to appear near the bottom or side of the image. The spatial prior for the sky 411 indicates that the sky tends to appear near the top and center of the image. The spatial prior for buildings 403 and the spatial prior for tree vegetation 409 indicate that buildings and tree vegetation tend to run across the top of images.

In one embodiment, the spatial prior distributions can be input into the cost function in order to provide another term that refines the semantic segmentation process in the target domain. In various embodiments, the spatial prior distribution is multiplied by the predicted class probability pₙ, and the target segmentation loss is determined from this product An exemplary loss function that involves spatial prior distributions is shown in Eq. (8):

$$\begin{matrix}min \\ \hat{y} , w\end{matrix} \{ - [ {\sum }_{s = 1}^{S} {\sum }_{n = 1}^{N} {y}_{s , n}^{T} log ( {p}_{n} ( w , {I}_{s} ) ) + {\sum }_{t = 1}^{T} {\sum }_{n = 1}^{N} {\sum }_{c = 1}^{C} {\hat{y}}_{t , n}^{( c )} log ( {p}_{n} ( c \vert w , {I}_{t} ) {q}_{n}^{( c )} ) + {\sum }_{c = 1}^{C} {k}_{c} {\hat{y}}_{t , n}^{( c )} ] \} \qquad Eq . ( 8 )$$

such that

ŷ_{t,n}^{T} ∈ {{e|e ∈ [symbol] ^{C}}∪0} Eq. (9)

Σₙqₙ^{(c)}=1/C Eq. (10)

k>0, ∀c Eq. (11)

In another aspect, smoothness found in a segmentation that occurs in the source domain can be used to provide smoothing in segmentation images in the target domain. Pixels that have similar features and are grouped in a same class in the source domain should be grouped together in the target domain.

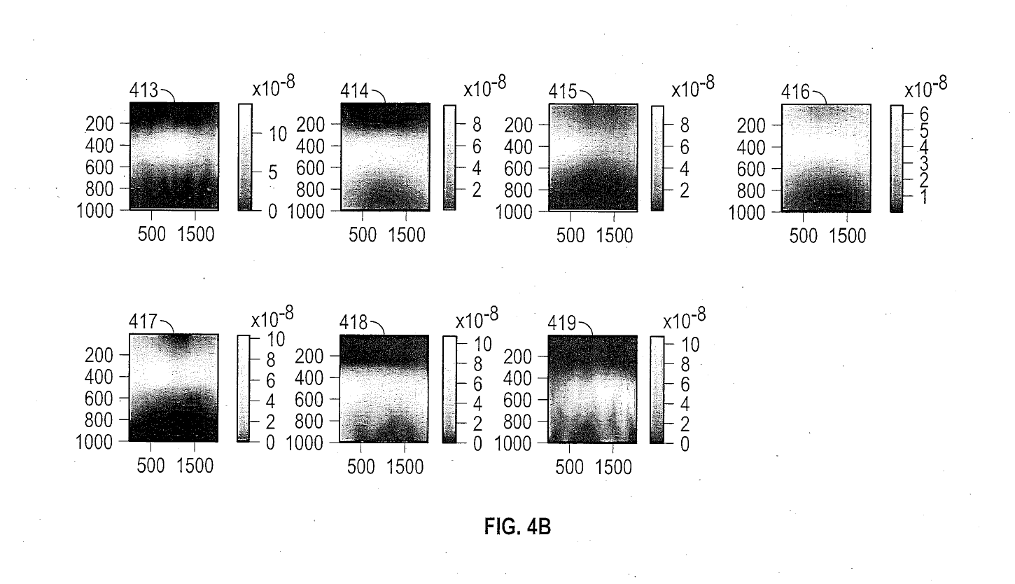

FIG. 5 shows an illustrative digital image 500 obtained in a target domain for semantic segmentation. The image 500 includes various feature classes, such as sky 502, vehicle 504, road 506 and vehicle hood 508.

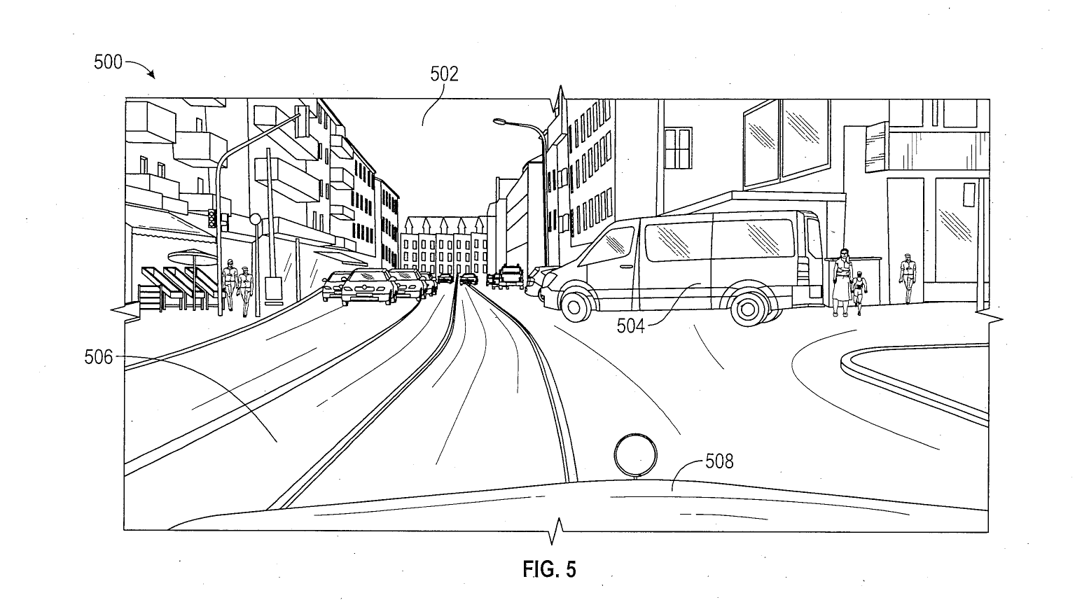

FIG. 6 shows an unaided semantic segmentation image 600 of the digital image 500. The sky class 602 clearly takes up less of the segmentation image 600 than sky 502 does of the digital image 500. Also, the vehicle 504 of digital image 500 is represented by two different feature classes, labelled 604a and 604b, in the segmentation image 600. The road class 606 of segmentation image 600 takes up only a portion of the segmentation image 600 whereas the corresponding road 506 of image 500 reaches from the left side to the right side of the digital image 500. Also, the hood class 608 appears to be much larger in the segmentation image 600 than the corresponding hood 508 does in the digital image 500.

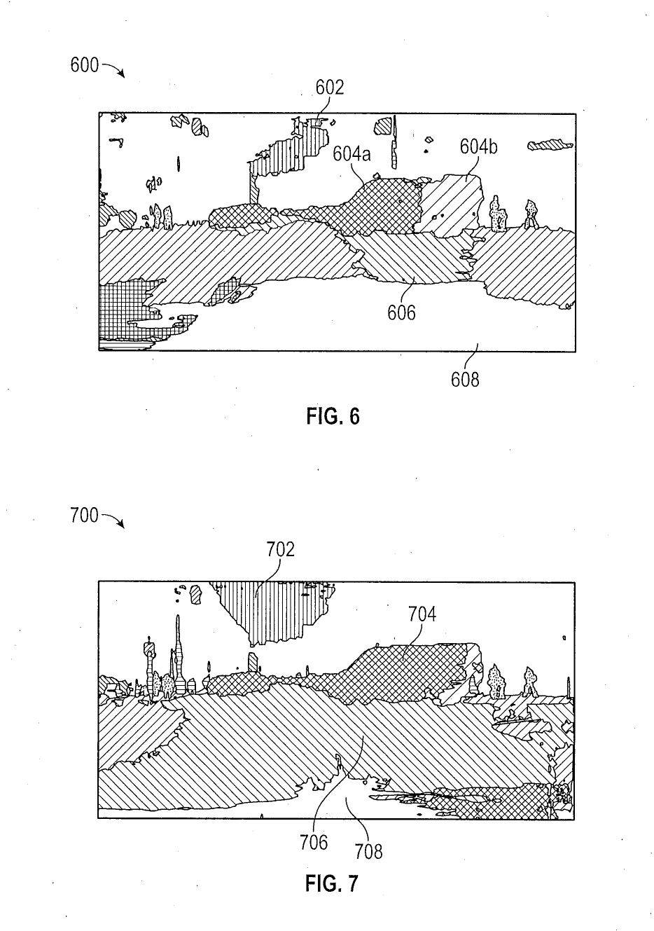

FIG. 7 shows a semantic segmentation image 700 after neural network adaptation (such as Eq. (5)) has been performed. The class features of image 700 are better proportioned to the features of the original image 500 than are the class features of image 600. In particular, the sky 702 more closely represents sky 502 of image 500 than does the sky 602 of image 600. The vehicle 504 is represented by a single class 704 in image 700. The road class 706 takes up much more of the image 700, just as does the road 506 of image 500. Additionally, the hood class 708 has been reduced to more closely conform to the size to the hood 508 of image 500.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A method of navigating a vehicle, comprising:
determining a target segmentation loss for training a neural network to perform semantic segmentation on a target domain image;
determining a value of a pseudo-label of the target image by reducing the target segmentation loss while providing a supervision of the training over the target domain;
performing semantic segmentation on the target image using the trained neural network to segment the target image and classify an object in the target image; and
navigating the vehicle based on the classified object in the target image.

2. The method of claim 1, further comprising determining a source segmentation loss for training the neural network to perform semantic segmentation on a source domain image, and reducing a summation of the source segmentation loss and the target segmentation loss while providing the supervision of the training over the target domain.

3. The method of claim 2, further comprising reducing the summation by adjusting parameters of the neural network and the value of the pseudo-label.

4. The method of claim 1, further comprising determining the value of the pseudo label of the target image by reducing the target segmentation loss over a plurality of segmentation classes while providing the supervision to each of the plurality of segmentation classes.

5. The method of claim 1, wherein determining the target segmentation loss further comprises multiplying the spatial prior distribution for the segmentation class by a class probability of a pixel being in the segmentation class.

6. The method of claim 1, further comprising training the neural network using adversarial domain adaptation training.

7. The method of claim 1, further comprising training the neural network using a self-training domain adaptation training.

8. The method of claim 1, wherein supervision of the training further comprises performing class-balancing for the target segmentation loss.

9. The method of claim 1, further comprising applying a smoothness algorithm to the semantic segmentation of the target image.

10. A navigation system for a vehicle, comprising:
a digital camera for capturing a target image of a target domain of the vehicle;
a processor configured to:
determine a target segmentation loss for training the neural network to perform semantic segmentation of the target image in the target domain;
determine a value of a pseudo-label of the target image by reducing the target segmentation loss while providing a supervision of the training over the target domain;
perform semantic segmentation on the target image using the trained neural network to segment the target image and classify an object in the target image; and
navigate the vehicle based on the classified object in the target image.

11. The navigation system of claim 10, wherein the processor is further configured to determine a source segmentation loss for training the neural network to perform semantic segmentation on a source domain image, and reduce a summation of the source segmentation loss and the target segmentation loss while providing the supervision of the training over the target domain.

12. The navigation system of claim 11, wherein the processor is further configured to reduce the summation by adjusting a parameter of the neural network and the value of the pseudo-label.

13. The navigation system of claim 10, wherein the processor is further configured to determine the value of the pseudo-label of the target image by reducing the target segmentation loss over a plurality of segmentation classes while providing the supervision to each of the plurality of segmentation classes.

14. The navigation system of claim 10, wherein the processor is further configured to multiply a spatial prior distribution for the segmentation class by a class probability of a pixel being in the segmentation class.

15. A vehicle, comprising:
a digital camera for capturing a target image of a target domain of the vehicle;
a processor configured to:
determine a target segmentation loss for training the neural network to perform semantic segmentation of the target image in the target domain;
determine a value of a pseudo-label of the target image by reducing the target segmentation loss while providing a supervision of the training over the target domain;
perform semantic segmentation on the target image using the trained neural network and the pseudo-label to segment the target image and classify an object in the target image; and
navigate the vehicle based on the classified object in the target image.

16. The vehicle of claim 15, wherein the processor is further configured to determine a source segmentation loss for training the neural network to perform semantic segmentation on a source domain image, and reducing a summation of the source segmentation loss and the target segmentation loss while providing the supervision of the training over the target domain.

17. The vehicle of claim 16, wherein the processor is further configured to reduce the summation by adjusting a parameter of the neural network and the value of the pseudo-label.

18. The vehicle of claim 15, wherein the processor is further configured to determine the value of the pseudo-label of the target image by reducing the target segmentation loss over a plurality of segmentation classes while providing the supervision to each of the plurality of segmentation classes.

19. The vehicle of claim 15, wherein the processor is further configured to multiply a spatial prior distribution for a segmentation class by a class probability of a pixel being in the segmentation class to determine the target segmentation loss.

20. The vehicle of claim 15, wherein the processor is further configured to apply a smoothness algorithm to the semantic segmentation of the target image.
